(19) United States
(12) Patent Application Publication
(10) Pub. No.: US 2006/0132035 A1
(43) Pub. Date: Jun. 22, 2006

(54) Image display apparatus and manufacturing method thereof

(76) Inventors: Yuichi Sawai, Hitachi (JP); Osamu Shiono, Hitachi (JP); Motoyuki Miyata, Hitachinaka (JP); Hiroyuki Akata, Hitachi (JP); Takashi Naito, Mito (JP); Noriyuki Oroku, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/312,690

(22) Filed: Dec. 21, 2005

(30) Foreign Application Priority Data
Dec. 22, 2004 (JP) 2004-372090

(51) Int. Cl. H01J 29/86; H01J 1/62

(52) U.S. Cl. 313/512

(57) ABSTRACT

The seal frame MFL interposed between the cathode panel PNL1 and the anode panel PNL2 along their peripheral portion is integrally formed with curved recesses CUV, concave in cross section, in its bonding surfaces in contact with the cathode panel PNL1 and the anode panel PNL2. This construction keeps the frit glass FG within the recesses CUV, preventing it from being squeezed out in the widthwise direction of the seal frame MFL. This in turn makes less likely the formation of penetrating holes in the frit glass, which will lead to a leakage. Thus, an airtightness improves, maintaining the vacuum level in the hermetically enclosed space, preventing a vacuum leakage caused by improper bonding between the two substrates, and realizing a highly reliable image display apparatus.

### CROSS-REFERENCE TO RELATED APPLICATION

This application relates to U.S. patent application Ser. No. ______ filed on December, 2005 based on Japanese Application Serial No. 2004-352737 filed on Dec. 6, 2004. The content of the application is incorporated herein by reference.

### BACKGROUND OF THE INVENTION

The present invention relates to an image display apparatus using an emission of electrons into a vacuum and more particularly to an image display apparatus having a display panel that seals the cathode panel and the anode panel with a seal frame,

the cathode panel having an electron source to emit electrons by a field emission,

the anode panel having a multicolor phosphor layer that is excited by electrons emitted from the cathode panel to produce light and an electron accelerating electrode. The invention also relates to a method of manufacturing the image display apparatus.

Color cathode ray tubes have long been in wide use as a display device with high resolution and brightness. As the image quality of information processing apparatus and television broadcasting improves, there are growing demands for a flat-panel display apparatus with a light weight and small occupying space as well as high resolution and brightness.

Typical examples of such display apparatus already on the market include a liquid crystal display and a plasma display. Among other types of planar display apparatus with improved brightness that are expected to be commercialized in near future are an electron emission type display or field emission type display using the electron emission from an electron source into a vacuum and an organic EL display with a feature of low power consumption. Here, the plasma display, the electron emission type display and the organic EL display, none of which requires an auxiliary illumination light source, are called image display apparatus.

Of these image display apparatus, the known field emission type displays include one having a cone-shaped electron emission structure devised by C. A. Spindt, one with a metal-insulator-metal (MIM) type electron emission structure, one with an electron emission structure (also called a surface conduction type electron source) that uses an electron emission phenomenon caused by a quantum tunneling effect, and one that makes use of the electron emission phenomenon of diamond films, graphite films and nanotubes such as carbon nanotubes.

A display panel making up the field emission type display, one example of the image display apparatus, comprises a cathode panel and an anode panel. The cathode panel is formed on its inner surface with a first electrode (e.g., cathode electrode) having a field emission type electron source and a second electrode as a control electrode (e.g., gate electrode and a scan electrode). The anode panel has on its inner surface facing the cathode panel a multicolor phosphor layer and a third electrode (anode electrode). The anode panel is suitably formed of a light transmitting glass material.

A seal frame is inserted between the two panels stuck together along their inside peripheries to seal an inner vacuum space formed by the cathode panel (back panel), the anode panel (front panel) and the seal frame. The cathode panel has a plurality of first electrodes with many electron sources and second electrodes formed on the back substrate of preferably an insulating material such as glass or alumina. The first electrodes extend in a first direction and are arranged parallel in a second direction crossing the first direction. The second electrodes extend in the second direction and are arranged parallel in the first direction.

The electron sources are provided at intersecting points of the first electrodes and the second electrodes. The amount of electrons emitted from the electron sources (including the start/stop of electron emission) is controlled by a potential difference between the first and second electrode. The emitted electrons are accelerated by a high voltage applied to the anode electrodes of the anode panel and impinge on the phosphor layer to excite it to illuminate in a color according to its illumination characteristic.

The seal frame is fixed to the inside peripheries of the cathode panel and the anode panel with a bonding material such as frit glass. The vacuum level of the inner space of the airtight glass vessel formed by the cathode panel, anode panel and seal frame is, for example, in the range of 10⁻⁵ to 10⁻⁷ Torr. For a display with a large display surface, a spacer is inserted between the cathode panel and the anode panel to hold them a predetermined distance apart.

Between the seal frame and the cathode panel there are first electrode lead terminals connecting to the first electrodes formed on the cathode panel and the second electrode lead terminals connecting to the second electrodes. Normally, the seal frame is fixed to the cathode panel and the anode panel with a bonding agent such as frit glass. The first electrode lead terminals and the second electrode lead terminals are drawn out through a seal area, a bonding portion between the seal frame and the cathode panel. An insulating film (also referred to as an interlayer insulating film) that insulates them is also provided in this seal area. Therefore, a vacuum leakage is likely to occur in this seal area.

Example measures against the vacuum leakage are disclosed in JP-A-2003-109521, JP-A-10-92381 and JP-A-7-226175. In a color cathode ray tube, an example construction is disclosed in JP-A-11-40081 in which a seal end face of a color cathode ray tube panel that corresponds to the seal area described above is formed with a plurality of undulations to protect against scores and contamination.

The image display apparatus of the above construction, however, has a problem. That is, as shown in FIG. 12A, an enlarged cross section of an essential part of the seal area, and in FIG. 12B, a plan view of the same, if the accuracy with which to apply the frit glass FG for securing the seal frame MFL to the panel glass (anode panel and cathode panel) SUB is low (as when too much of the frit glass is applied), a portion of the frit glass FG that is squeezed out from under the seal frame MFL in the width direction is easily cracked at a point E in the figure, accelerating a vacuum leak and degrading the airtightness, with the result that the vacuum level in the inner space (hermetic space) formed by the panel glass SUB and the seal frame MFL deteriorates, impairing reliability of the image display apparatus.

Similarly, as shown in FIG. 12A and FIG. 12B, a portion of the frit glass FG that is squeezed out in the width direction of the seal frame MFL adheres to the electrode surfaces of the first electrodes (and the first electrode lead terminals), the second electrodes (and the second electrode lead terminals) and the third electrodes, all formed on the surface of the panel glass SUB. In removing the squeezed-out portion, these electrodes may be damaged, leading to their conductivity degradation and wire breaks, impairing the reliability of the image display apparatus.

If the top and bottom surfaces of the seal frame MFL are flat and the amount of frit glass FG applied in the width direction is not constant, e.g., the frit glass application amount is too small, a weak vacuum seal portion WEK is formed as shown, increasing the likelihood of a crack CRK being formed in the width direction due to a difference in thermal expansion coefficient between the panel glass SUB and the frit glass FG. This in turn accelerates the vacuum leakage, degrading the airtightness and lowering the vacuum level in the inner space (hermetic space) formed by the panel glass SUB and the seal frame MFL. As a result, the reliability of the image display apparatus is similarly impaired.

There is another problem. Since the seal frame MFL is formed by using four glass rods GB1, GB2, GB3, GB4 with inclined end surfaces, assembling them into a frame as shown in the plan view of FIG. 13 and bonding the joint surfaces JON with frit glass, small gaps are easily formed between the joint surfaces JON and will likely cause a vacuum leakage. This construction therefore degrades the vacuum level in the hermetic space, impairing the reliability of the image display apparatus.

Further, since during transport, a large number of seal frames MFL are stacked in layers as shown in a perspective view of FIG. 14, almost all the volume of the stacked material is occupied by an air space, making the transport cost high.

### SUMMARY OF THE INVENTION

The present invention has been accomplished to overcome the above problems experienced by the conventional apparatus and its object is to provide an image display apparatus with a highly reliable display panel which can prevent degradations in conductivity and vacuum level caused by improper application of a bonding material that bonds together the anode panel, the cathode panel and the seal frame and also prevent formation of cracks caused by a difference in thermal expansion coefficient.

To achieve the above objective, the present invention provides an image display apparatus in which the seal frame that is interposed between the cathode panel and the front panel along their peripheral portion to seal them together is integrally formed with recesses, concave in cross section, in its bonding surfaces in contact with the cathode panel and anode panel so that the sealing material can stay in the recesses easily, making it more difficult for the sealing material to flow out onto the panel glass surfaces. The problems discussed in the background of the invention therefore can be solved by this construction.

In another image display apparatus according to this invention, the seal frame of the above construction is preferably formed of a glass material containing 1-20% by weight of at least one rare earth oxide chosen from among La, Sc, Y, Ce, Pr, Nd, Pm, Sm, Eu, Gd, Tb, Dy, Ho, Er, Tm, Yb and Lu with silicon oxide as a main component (hereinafter referred to as nanoglass) to enable the recesses to be formed easily, thus overcoming the problems discussed in the background of the invention.

In still another image display apparatus according to this invention, the seal frame of the above construction preferably has a curved portion with a radius of curvature of 0.1 mm or less at four corners so that the joint surfaces of the seal frame rods can be joined airtightly, thus solving the problems discussed in the background of the invention.

It is noted that the present invention is not limited to the constructions described above or to those constructions of embodiments described in the following and that various changes can be made without departing from the technical philosophy of this invention.

In the image display apparatus of this invention, since the seal frame is integrally formed with recesses, concave in cross section, in its bonding surfaces in contact with the cathode panel and the anode panel, the sealing material can reliably stay in these recesses regardless of the amount of sealing material applied. Therefore a high vacuum seal structure can be obtained that makes it difficult for the sealing material to be squeezed out in the width direction of the seal frame, thus preventing degradations in conductivity and vacuum level caused by improper application of a sealing material and also preventing formation of cracks caused by a thermal expansion coefficient difference. This construction therefore can produce an excellent effect of being able to provide an image display apparatus with a highly reliable display panel.

In the image display apparatus of this invention, since the seal frame is molded of a nanoglass material, the seal frame with recesses can be fabricated with ease and high precision. It is therefore possible to manufacture highly reliable image display apparatus with high productivity and at low cost.

Further, in the image display apparatus of this invention, since the provision of a curved portion with a radius of curvature of 0.1 mm or less at four corners of the seal frame enables the seal frame rods to be bonded together airtightly without squeezing the sealing material from their joint surfaces, there is a great advantage of being able to provide an image display apparatus with a highly reliable display panel.

Further, according to the method of manufacturing the image display apparatus of this invention, the seal frame is integrally formed with recesses, concave in cross section, in its bonding surfaces in contact with the cathode panel and the anode panel. The sealing material is filled into these recesses and the cathode panel and the anode panel are bonded together with the sealing material interposed in between to hermetically seal the panels. This manufacturing method allows the sealing material to reliably stay in these recesses regardless of the amount of the sealing material applied, making it possible to easily manufacture a high vacuum sealing structure in which the sealing material can hardly be squeezed out in the widthwise direction of the seal frame. Thus a highly reliable display panel can be obtained.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic plan view showing the construction of embodiment 1 of an image display apparatus according to this invention.

FIG. 2A is a partial cross-sectional view taken along the line A-A′ of the image display apparatus of FIG. 1.

FIG. 2B is a cross-sectional view taken along the line B-B′ of FIG. 1.

FIG. 2C is a partial cross-sectional view taken along the line C-C′ of FIG. 1.

FIG. 3A is a plan view of the seal frame of FIGS. 2A to 2C.

FIG. 3B is an enlarged cross-sectional view taken along the line A-A′ of FIG. 3A.

FIG. 4 is a cross-sectional view showing the construction of the seal frame according to this invention.

FIGS. 5A and 5B are schematic diagrams showing a seal structure of the seal frame according to this invention.

FIG. 6 is an essential part enlarged cross-sectional view showing the construction of another embodiment of the seal frame according to this invention.

FIGS. 7A and 7B are essential part enlarged cross-sectional views showing the construction of still another embodiment of the seal frame according to this invention.

FIG. 8 is a process flow diagram showing the method of manufacturing the image display apparatus according to this invention.

FIG. 9 is a partly cutaway perspective view showing an example overall construction of the image display apparatus according to this invention.

FIG. 10 is a cross-sectional view taken along the line A-A′ of FIG. 9.

FIG. 11 is an explanatory diagram showing an equivalent circuit of the image apparatus applying the construction of this invention.

FIGS. 12A and 12B are schematic diagrams showing a seal structure of a conventional seal frame.

FIG. 13 is an essential part plan view showing an assembled structure of the conventional seal frame.

FIG. 14 is an essential part perspective view showing the conventional seal frames while being transported.

### DETAILED DESCRIPTION OF THE EMBODIMENTS

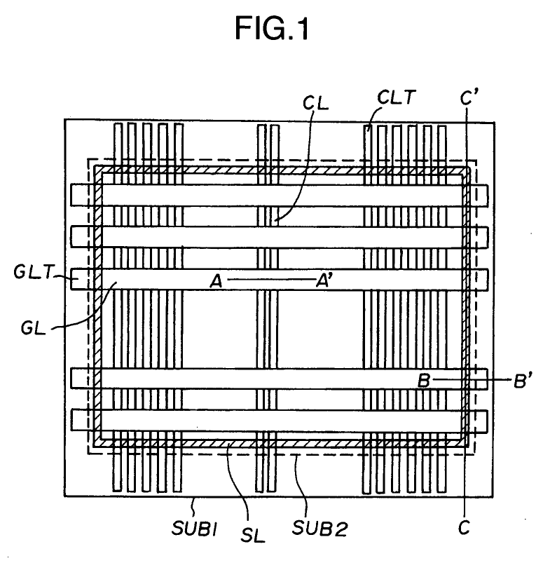

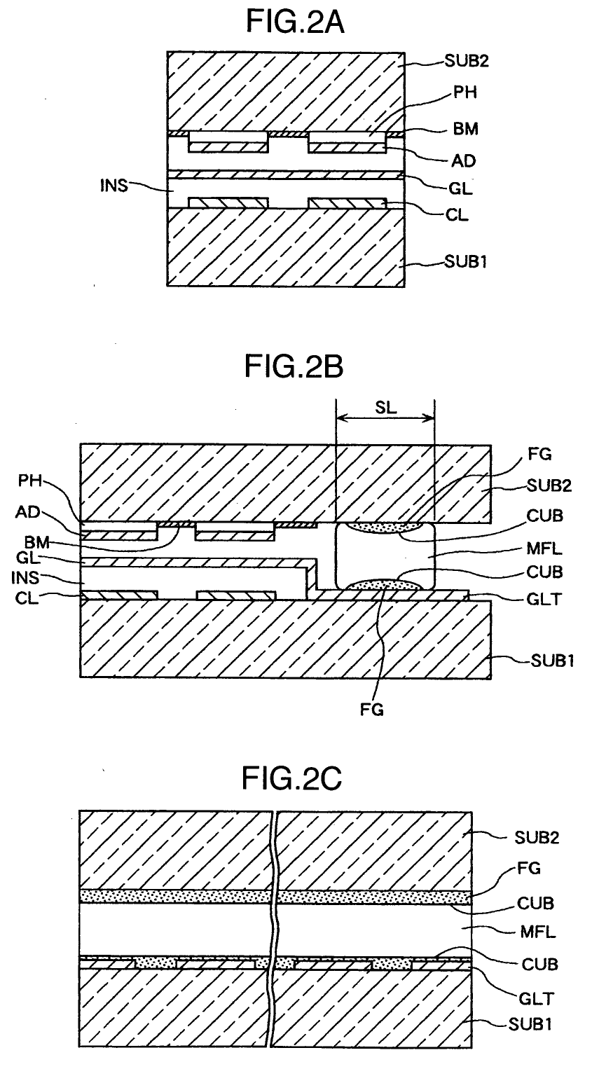

Embodiments of the present invention will be described by referring to the accompanying drawings. First, an embodiment 1 of this invention is explained by referring to FIG. 1 and FIG. 2.

FIG. 1 is a plan view showing an inner surface structure of the cathode panel to explain embodiment 1 of the display panel making up the image display apparatus of this invention. FIG. 2A is a partial cross-sectional view taken along the line A-A′ of FIG. 1; FIG. 2B is a partial cross-sectional view taken along the line B-B′ of FIG. 1; and FIG. 2C is a partial cross-sectional view taken along the line C-C′ of FIG. 1. In the plan view of FIG. 1, the anode panel is represented by a dashed line that indicates an outline of its substrate (front substrate) SUB2.

In FIG. 1 and FIG. 2, interposed between the cathode panel and the anode panel is a seal frame MFL which has recesses CUV (described later) formed concave in cross section in its bonding surfaces, that are in contact with the cathode panel and the anode panel, along the inside outer peripheries of the two panels. These recesses are filled with frit glass FG and the two panels are sealed together airtightly with the frit glass FG in between. An area sealed by the seal frame MFL is indicated by SL.

In the cathode panel, first electrodes CL and second electrodes GL are formed on a back substrate SUB1. In FIG. 2, first electrode lead terminals CLT are formed at the ends of the first electrodes and second electrode lead terminals GLT are formed at the ends of the second electrodes GL. In the embodiments that follow, the first electrodes CL are described as cathode electrodes, the first electrode lead terminals CLT as cathode electrode lead terminals CLT, the second electrodes GL as gate electrodes, and the second electrode lead terminals GLT as gate electrode lead terminals.

The cathode electrodes CL are shaped like stripes, extend in a first direction (vertical direction in the figure) on the back substrate SUB1 and are arranged parallel in large numbers in a second direction (horizontal direction in the figure) crossing the first direction. Covering these cathode electrodes CL is an insulation film (interlayer insulation film) INS. Over this insulation film are formed a large number of gate electrodes GL that extend in the second direction and are arranged parallel in the first direction. The gate electrodes GL are also stripe electrodes. At the ends of the cathode electrodes CL are formed cathode electrode lead terminals CLT.

While FIG. 1 shows a construction in which the cathode electrode lead terminals CLT are provided at both ends of the cathode electrodes CL, they may be formed at only one end. Similarly, the gate electrode lead terminals GLT are formed at the ends of the gate electrodes GL. Although the gate electrode lead terminals GLT are shown to be formed at both ends of the gate electrodes GL, they may be formed at only one end.

An inside of the seal area SL is a display area, in which electron sources are arranged at intersections of the cathode electrodes CL and the gate electrodes GL. The electron sources are, for example, MIM electron sources of a construction described later. These electron sources emit an amount of electrons, according to image data supplied from the cathode electrode lead terminals CLT, to cathode electrodes CL crossing a gate electrode GL selected by a vertical scan signal successively input from the gate electrode lead terminals GLT.

A layer structure of the cathode electrodes CL and the gate electrodes GL in the display area is shown in FIG. 2A. FIG. 2A is also a schematic diagram that does not show the electron sources. The cathode electrodes CL are formed on the back substrate SUB1. Over the cathode electrodes CL is formed an interlayer insulation film INS which is made of, for instance, silicon nitride (SiN). Over the interlayer insulation film INS is formed the gate electrodes GL. The ends of the gate electrodes GL are gate electrode lead terminals GLT drawn out of the seal area SL.

The interlayer insulation film INS, as shown in FIG. 2B, is formed up to a short distance inside from the seal area SL so that it is kept out of contact with the frit glass FG that bonds the seal frame MFL. In embodiment 1, frit glass containing lead oxide (PbO) was used as the sealing material FG. As shown in FIG. 2C, the gate electrode lead terminals GLT and the frit glass FG are interposed between the back substrate SUB1 forming the cathode panel and the seal frame MFL.

As shown in FIG. 2A and FIG. 2B, on the inner surface of the front substrate SUB2, phosphor layers PH and anode electrodes AD as a third electrode are formed in layer at locations facing the electron sources formed on the back substrate SUB1. Between the phosphor layers PH on the inner surface of the front substrate SUB2 are formed black matrix films BM that separate the illuminating colors of the phosphor layers PH. Then, the electrons emitted from the electron sources are accelerated to impinge on the corresponding phosphor layers PH, causing the phosphor layers PH to illuminate in predetermined colors to form an intended color image.

As shown in FIG. 2B, the seal frame MFL, which is interposed between the back substrate SUB1 forming the cathode panel and the front substrate SUB2 forming the anode panel and extends along their inside peripheries, is integrally formed with curved recesses CUV, concave in cross section, in its bonding surfaces in contact with the back substrate SUB1 and front substrate SUB2. With the two recesses CUV filled with frit glass FG, the seal frame MFL hermetically seals the two panels.

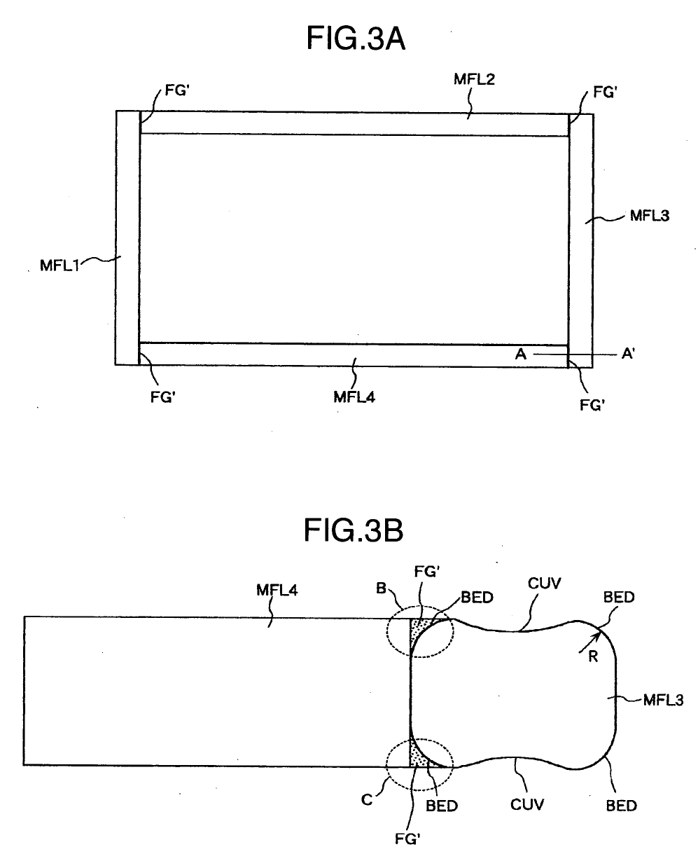

FIG. 3 is an enlarged view showing a detailed structure of the seal frame MFL of FIG. 2. FIG. 3A is a plan view and FIG. 3B is an enlarged cross section of an essential part taken along the line A-A′ of FIG. 3A. In FIG. 3A, the process of making the seal frame MFL involves forming, for example, a nanoglass material with a reinforced glass strength into bars by a glass redraw process, assembling the four seal frame rods MFL1, MFL2, MFL3, MFL4 into a frame, and joining the joint surfaces at the ends of the seal frame rods with a joint frit glass FG′.

The seal frame MFL is integrally formed with curved surfaces BED having a radius of curvature R of 0.1 mm or less at four corners, as shown in FIG. 3B. In this structure, as shown in FIG. 3B, on a joint surface between the seal rod MFL4 and the adjoining seal rod MFL3 there are formed frit glass accommodation spaces, roughly triangular in cross section, as indicated at B and C. Since the joint frit glass FG′ is accommodated in the frit glass accommodation spaces, vertically bulged portions of the joint frit glass FG′ are not formed, with the result that the seal frame rods MFL1-MFL4 form a flat surface and are firmly connected. This allows a large number of seal frames MFL stacked in layers in a variety of combinations, increasing the volume density and allowing for a large volume transport. This in turn reduces the transport cost.

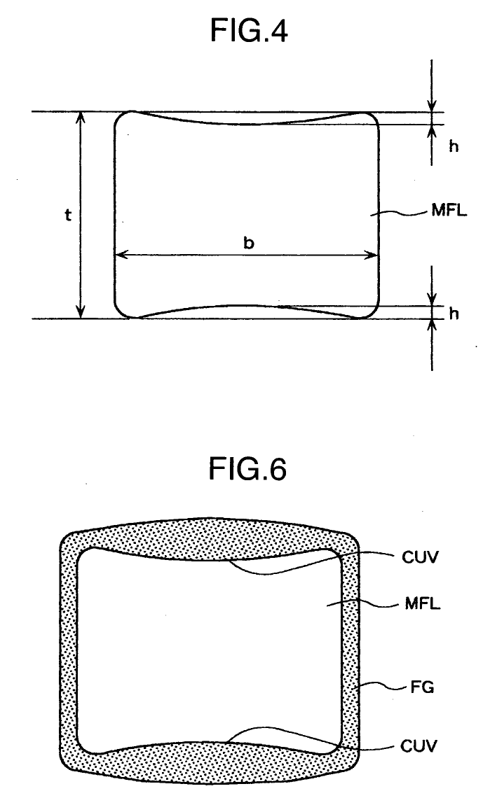

The curved recesses CUV, concave in cross section, to accommodate the seal frit glass FG are integrally formed in the bonding surfaces of the seal frame MFL that are in contact with the cathode panel and the anode panel. As shown in the enlarged cross section of FIG. 4, the curved recesses CUV have a depth h of about 1.0 mm when the height t of the seal frame MFL is about 3 mm and the width b is 6 mm.

In this construction, penetrating holes, a cause for leakage, hardly form in the seal frit glass FG that seals a space between the back substrate SUB1 and the front substrate SUB2 that are put in hermetic contact with the top and bottom surfaces of the seal frame MFL. This improves airtightness and can keep the vacuum level in the airtight space, thus preventing a possible vacuum leakage associated with the bonding of the two substrates. It is therefore possible to realize a highly reliable image display apparatus with a reduced possibility of vacuum leakage in the seal area.

Since the seal frame MFL constructed as described above has curved recesses CUV integrally formed in its bonding surfaces in contact with the cathode panel and the anode panel, the frit glass FG can be applied easily to only the interior of the curved recesses CUV as by the dispenser method or printing method, regardless of the precision in the amount of material applied, so that it is confined within a predetermined width of the seal area SL and prevented from overrunning from the sides of the seal frame MFL (inside and outside).

Further, the provision of the curved recesses CUT in the top and bottom surfaces of the seal frame MFL has produced the following advantages. The frit glass FG applied into the recesses CUT is prevented by the side walls of the recesses CUV from getting out to the inner or outer side of the recesses with respect to the panel glass surface. This also makes it difficult for gases generated from the frit glass FG to enter into the inner side of the recesses. On the outer side of the recesses, this construction also prevents the frit glass FG from adhering to the surfaces of the cathode electrodes CL (and cathode electrode lead terminals CLT) and the gate electrodes GL (and gate electrode lead terminals GLT), both formed on the cathode panel surface, and the anode electrodes. Since the process of removing the overrunning portions is obviated, the possibility of damaging these electrodes and lowering the conductivity and of wire breaks can be eliminated.

While in this embodiment, the seal frame MFL has been described to be constructed by assembling four seal frame rods MFL1, MFL2, MFL3, MFL4, one for each side, it may be formed as one integral frame. The curved surfaces BED can easily be formed by forming curved surfaces in the interior of a mold at portions corresponding to the curved surfaces BED, the mold being used to mold nanoglass material into rods of the seal frame MFL.

Further, in this embodiment, an example case has been described in which recesses CUV 6 mm wide (b), 3 mm high (t) and about 1 mm deep (h) are integrally formed in the top and bottom surfaces of the seal frame MFL as shown in FIG. 4. An airtightness test was conducted by using 17-inch panels fabricated by changing the depth (h) of the seal frame MFL and evacuating and sealing these panels. In the test the number of samples tested was n=2 for each depth and the airtightness was evaluated in a depth range of between 0.5 mm and 2.0 mm. The result is shown in Table 1 below.

TABLE 1

| Depth of | | Number of samples | |
|---|---|---|---|
| recess h (mm) | h/b | with leakage (n) | Air-tightness |
| 0.5 | 0.1 | 0 | Good |
| 1.0 | 0.2 | 0 | Good |
| 1.5 | 0.3 | 1 | Fair |
| 2.0 | 0.3 | 2 | Bad |

As can been seen from Table 1, samples with the height (h) in excess of about 1 mm had a vacuum leakage, while those less than 1 mm in height had no vacuum leakage at all. As for the leakage, it is confirmed that no leakage occurred with Pb-based frit glass or V-based frit glass. This indicates that the leakage prevention performance does not depend on the material of the frit glass. Therefore, the most preferable range of depth (h) of the curved recesses CUV formed in the top and bottom surfaces of the seal frame MFL is between 0.5 mm and 1.0 mm.

Further, in this embodiment we have described a case in which the curved surfaces BED with a radius of curvature R of less than 0.1 mm are integrally formed at four corners of the seal frame MFL, as shown in FIG. 3B. An airtightness test was conducted by using 17-inch panels with different radii of curvature R of the seal frame MFL and evacuating and sealing these panels. In the test the number of samples tested was n=3 for each radius of curvature at the four corners of the seal frame MFL and the airtightness was evaluated in a curvature radius range of between 1 mm and 0.05 mm. The result is shown in Table 2 below.

| | | Number of samples | |
|---|---|---|---|
| R (mm) | General frit glass | with leakage (n) | Air-tightness |
| 1 | Pb-based frit glass | 3 | Bad |
| 0.8 | Pb-based frit glass | 3 | Bad |
| 0.6 | Pb-based frit glass | 3 | Bad |
| 0.4 | Pb-based frit glass | 2 | Fair |
| 0.2 | Pb-based frit glass | 0 | Good |
| 0.1 | Pb-based frit glass | 0 | Good |
| 0.05 | Pb-based frit glass | 0 | Good |
| 1 | V-based frit glass | 3 | Bad |
| 0.8 | V-based frit glass | 3 | Bad |
| 0.6 | V-based frit glass | 3 | Bad |
| 0.4 | V-based frit glass | 1 | Fair |
| 0.2 | V-based frit glass | 0 | Good |
| 0.1 | V-based frit glass | 0 | Good |
| 0.05 | V-based frit glass | 0 | Good |

As can be seen from Table 2, samples with the radius of curvature R at the corners in excess of about 0.4 mm had a vacuum leakage, while those less than 0.2 mm in the radius of curvature R had no vacuum leakage at all. As for the leakage, it is confirmed that no leakage occurred with Pb-based frit glass or V-based frit glass. This indicates that the leakage prevention performance does not depend on the material of the frit glass. Therefore, the most preferable range of radius of curvature R of the curved surfaces BED formed at four corners of the seal frame MFL is between 0.05 mm and 0.2 mm.

The seal frame MFL, which has the curved recesses CUT in its top and bottom surfaces and the curved surfaces BED at four corners, can be manufactured easily to be lightweight at low cost by the redraw process using a glass reflow device and nanoglass material.

In the above embodiment, an example case has been described in which the seal frame MFL is integrally formed with curved recesses CUV in its upper and lower surfaces and the curved surfaces BED at its four corners and in which these recesses CUV are filled with the frit glass FG by the dispenser method or printing method before bonding the cathode panel and the anode panel together. As shown in an enlarged cross-sectional view of FIG. 6, the seal frame MFL may be covered with a melted frit glass FG over its outer surface as by dipping and then heated and temporarily dried to form a seal frame structure covered with the frit glass. This structure was found to produce the similar effect.

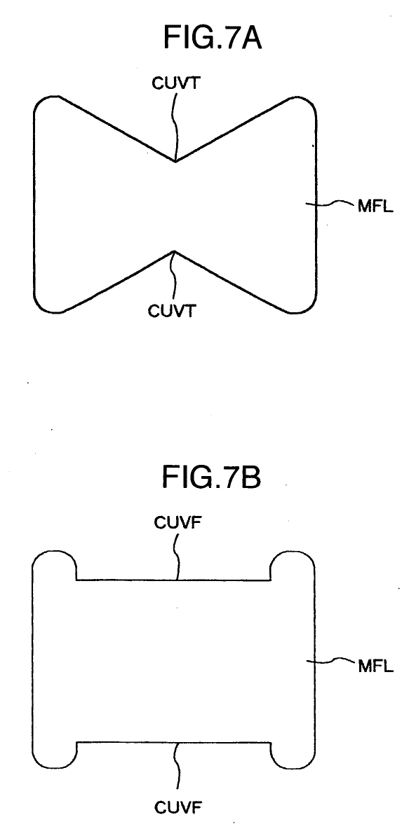

Further, in the above embodiment, an example case has been explained in which the recesses CUV formed concave in cross section in the top and bottom surfaces of the seal frame MFL have a smoothly curved bottom. The present invention is not limited to this shape. For example, the seal frame MFL may have recesses CUVT triangular in cross section, as shown in an essential part enlarged cross section of FIG. 7A or it may have recesses CUVF with a flat surface at the bottom, as shown in an essential part enlarged cross section of FIG. 7B. Further, this invention is not limited to any of combinations of these cross-sectional structures nor to any depth or shape. Since large volume frit glass accommodation spaces are formed in a variety of recesses CUVT, CUVF and a large amount of frit glass can be kept in these spaces, the airtightness can be improved further, reliably preventing the vacuum leakage.

In the above embodiment, we have described an example panel structure which has no space keeping member (or spacer) for keeping a predetermined distance between the back substrate and the front substrate. The present invention is not limited to this structure. It is of course possible to apply this invention to a panel structure using the spacer between the two substrates and produce the exactly the same effect.

Next, the method of manufacturing the image display apparatus according to this invention will be explained.

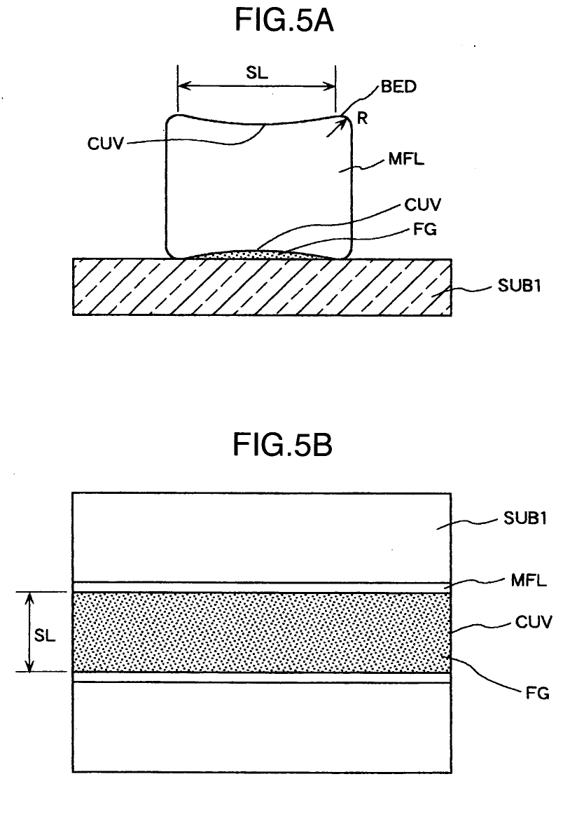

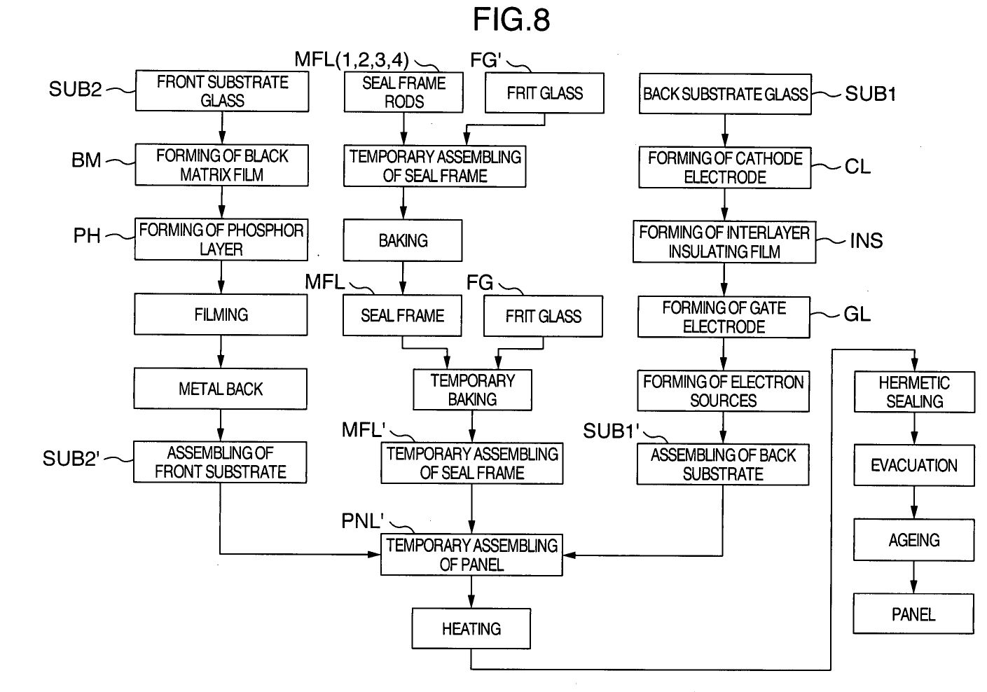

FIG. 8 is a process flow showing the method of manufacturing the image display apparatus of this invention. Components identical with those of FIG. 1 to FIG. 7 are given like reference numbers.

In FIG. 8, the front substrate SUB2 is formed with a phosphor surface made up of black matrix films BM, phosphor layers PH and anode electrodes AD. The phosphor surface is then formed with a filming layer and a metal back layer to construct a front substrate assembly SUB2′.

On the back substrate SUB1, a plurality of cathode electrodes CL and cathode electrode lead terminals CLT, extending in an x direction and arranged side by side in a y direction crossing the x direction, are formed. After this, an interlayer insulation film INS is formed, over which gate electrodes GL and gate electrode lead terminals GLT are formed. Then, electron sources are formed on the plurality of cathode electrodes CL to construct a back substrate assembly SUB1′.

The seal frame MFL is fabricated in a separate process described later.

That is, a seal rod which is integrally formed with curved surfaces BED at four corners and with curved recesses CUV, concave in cross section, in its two opposite surfaces by the redraw process using a nanoglass material and a glass reflow device, for example. Next, this seal rod is cut into predetermined lengths to produce seal frame rods MFL1, MFL2, MFL3, MFL4.

The joint surfaces of these seal frame rods MFL1, MFL2, MFL3, MFL4 are applied with a glass paste, which is made by mixing a joint frit glass FG′ and a specified binder. The seal frame rods are assembled and set in a predetermined array in a jig and baked at a bonding temperature of about 480° C. for about 10 minutes under pressure to dissipate the binder and form a seal frame MFL.

Next, a glass paste, made by mixing a seal frit glass FG with a softening temperature of about 390° C. and a sealing temperature of about 430° C. and a predetermined binder, is applied by the dispenser method or printing method into the curved recesses CUB formed in the top and bottom surfaces of the seal frame MFL. The seal frame MFL is then temporarily baked at 150° C.—a temperature at which the binder is eliminated—to form a seal frame assembly MFL′ in which the frit glass FG is temporarily fixed to the recesses CUB.

Then, the front substrate assembly SUB2′, the back substrate assembly SUB1′ and the seal frame assembly MFL′ are stacked together to form a preliminary panel assembly PNL′. This preliminary panel assembly PNL′ is heated at about 430° C., lower than the softening temperature of the joint frit glass FG′, for about 10 minutes under pressure to hermetically join the back substrate SUB1, the front substrate SUB2 and the seal frame MFL with the seal frit glass FG.

Next, an airtight space or a display area enclosed by the back substrate SUB1, the front substrate SUB2 and the seal frame MFL is evacuated and baked through an exhaust pipe not shown. The evacuation baking is performed by installing the preliminary panel assembly PNL′ in a vacuum furnace and heating it for several hours at a maximum temperature of about 380° C., lower than the softening temperature of the frit glass FG′, FG. In a panel structure with no exhaust pipe, this evacuation baking process may be performed simultaneously with the hermetic sealing. Then, in a panel structure with an exhaust pipe, the space is evacuated to about 1 μPa and the exhaust pipe is chipped off. The panel structure is further subjected to predetermined processing such as ageing to manufacture an image display apparatus.

According to this manufacturing method, in a hermetic sealing process using the seal frame MFL, which is integrally formed with curved surfaces BED at its four corners and curved recesses CUV in its top and bottom surfaces, and in the subsequent heating process, the baking is done at a temperature lower than the softening temperature of the frit glass FG′, FG. This prevents a melting or softening of the seal frit glass FG that hermetically joins the seal frame rods together and which also hermetically joins the seal frame rods MFL, the back substrate SUB1 and the front substrate SUB2. Thus, the seal frame rods are firmly and airtightly joined together, and the seal frame MFL, back substrate SUB1 and front substrate SUB2 are also firmly joined hermetically. Therefore, a displacement of these members and a vacuum leakage in the seal area can be avoided completely, allowing the seal frame MFL to perform its function to the full extent.

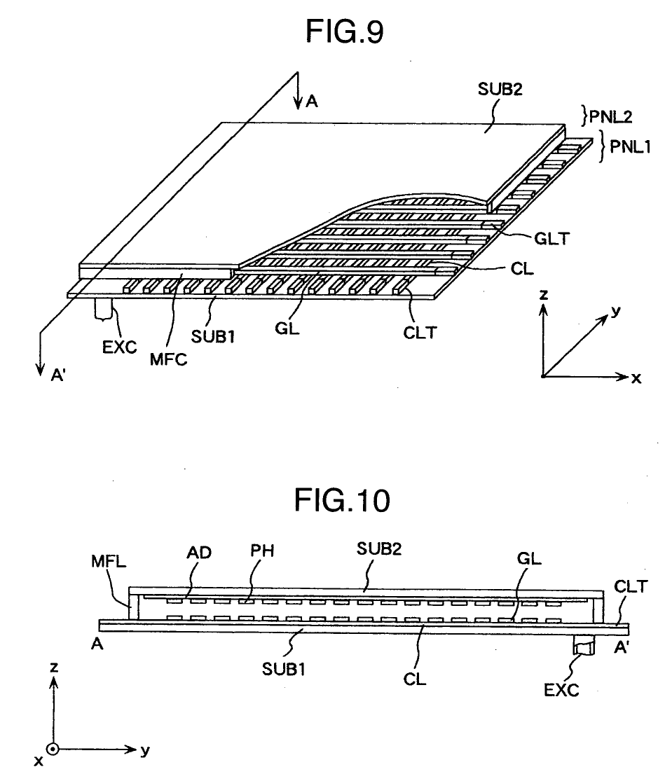

FIG. 9 is a partly cutaway perspective view showing an example overall construction of the image display apparatus of this invention. FIG. 10 is a cross-sectional view taken along the line A-A′ of FIG. 9. On the inner surface of the back substrate SUB1 forming the back panel, the cathode electrodes CL and the gate electrodes GL are formed. At intersections between the cathode electrodes CL and the gate electrodes GL are formed electron sources. At the end of the cathode electrodes CL are formed the cathode electrode lead terminals CLT, and at the end of the gate electrodes GL are formed the gate electrode lead terminals GLT.

On the inner surface of the front substrate SUB2 that constitutes the anode panel, the anode electrodes AD and the phosphor layers PH are formed. The back substrate SUB1 constituting the cathode panel PNL1 and the front substrate SUB2 constituting the anode panel PLN2 are stuck together with the seal frame MFL interposed between the two substrates along their peripheral portion. To keep the gap between the substrates at a predetermined distance, a space keeping member (or spacer) of preferably a glass plate is inserted between the cathode panel PNL1 and the anode panel PNL2. This is not shown in FIG. 9 and FIG. 10.

An inner space hermetically enclosed by the cathode panel PNL1, the anode panel PNL2 and the seal frame MFL is kept in a predetermined vacuum state by evacuation through an exhaust pipe EXC installed on a part of the cathode panel PNL1.

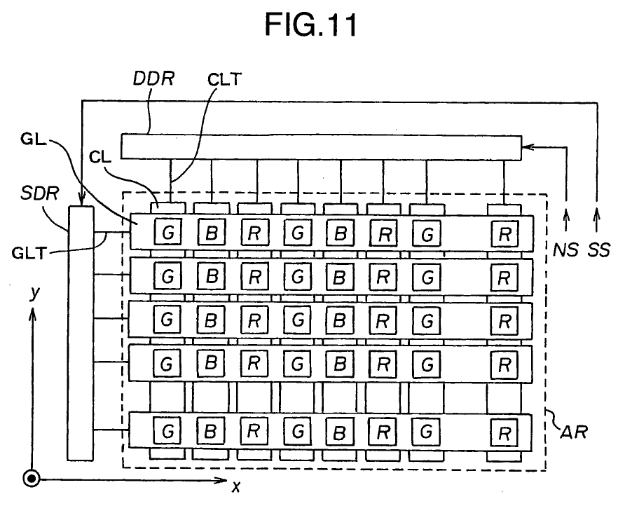

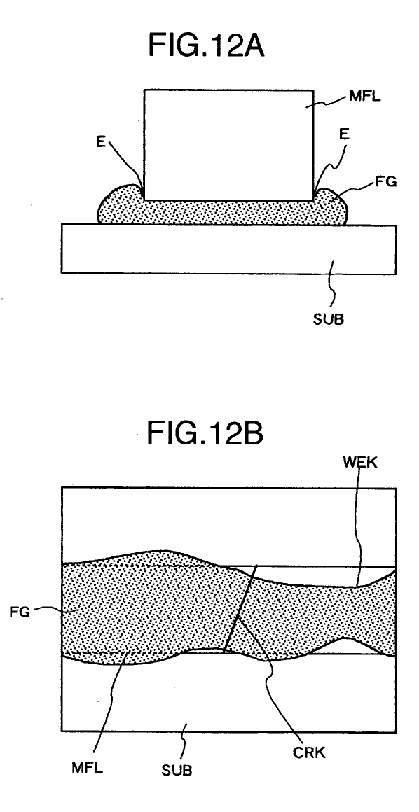

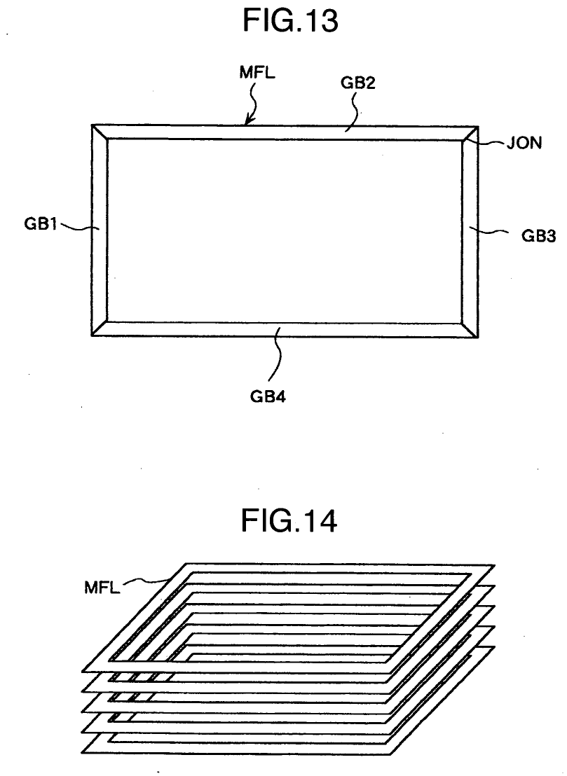

FIG. 11 is an explanatory diagram showing an example equivalent circuit of an image display apparatus applying the construction of this invention. An area shown dashed in FIG. 11 is a display area AR, in which n cathode electrodes CL and m gate electrodes GL are arranged to intersect each other to form an n×m matrix. Each intersection of the matrix forms a subpixel. One group of three unit pixels (or subpixels) R, G, B constitutes one color pixel. The construction of the electron sources is not shown. The cathode electrodes CL are connected to an image signal drive circuit DDR through the cathode electrode lead terminals CLT, and the gate electrodes GL are connected to a scan signal drive circuit SDR through the gate electrode lead terminals GLT. The image signal drive circuit DDR is supplied an image signal NS from an external signal source, and the scan signal drive circuit SDR is similarly supplied a scan signal SS.

A two-dimensional full color image can be displayed by supplying an image signal to the cathode electrodes CL that cross a successively selected gate electrode GL. By using the display panel of this construction, an image display apparatus with high efficiency at relatively low voltage can be realized.

While the above embodiment has taken up an example case in which the electron sources are of MIM type, this invention is not limited to this configuration. It is also possible to apply this invention to a self-illuminating type flat panel display using a variety of kinds of electron sources and still produce the same effect.

It should be further understood by those skilled in the art that although the foregoing description has been made on embodiments of the invention, the invention is not limited thereto and various changes and modifications may be made without departing from the spirit of the invention and the scope of the appended claims.

1. An image display apparatus comprising:
a cathode panel having a display area formed on a back substrate, the display area having a number of first electrodes extending in a first direction and arranged side by side in a second direction crossing the first direction, an insulating film formed to cover the first electrodes, a number of second electrodes extending in the second direction and arranged side by side in the first direction on the insulating film, and a number of pixels arranged at intersections of the first electrodes and the second electrodes, each of the pixels having an electron source;
an anode panel having formed on a front substrate a plurality of colors of phosphor layers excited to illuminate by electrons from the electron sources in the display area on the cathode panel, and third electrodes; and
a seal frame having a seal member interposed between the cathode panel and the anode panel along their circumferential portion to hermetically join the two panels;
wherein the seal frame has integrally formed recesses, concave in cross section, in its bonding surfaces in contact with the cathode panel and the anode panel.

2. An image display apparatus according to claim 1, wherein the seal frame is formed of a glass material containing silicon oxide as a main component and 1-20% by weight of at least one kind of rare earth oxide chosen from La, Sc, Y, Ce, Pr, Nd, Pm, Sm, Eu, Gd, Tb, Dy, Ho, Er, Tm, Yb and Lu.

3. An image display apparatus according to claim 1, wherein the seal frame has curved portions at its four corners, the curved portions having a radius of curvature set at 0.1 mm or less.

4. An image display apparatus according to claim 1, wherein the seal frame comprises a plurality of seal frame rods and the seal frame rods are hermetically joined with each other through a joint member.

5. An image display apparatus according to claim 1, wherein the seal member has as a main component frit glass selected from a group of Pb-based frit glass and V-based frit glass.

6. An image display apparatus according to claim 1, wherein the joint member has as a main component frit glass selected from a group of Pb-based frit glass and V-based frit glass.

7. An image display apparatus according to claim 5, wherein the joint member has a higher softening temperature than that of the seal member.

8. A method of manufacturing an image display apparatus, wherein the image display apparatus comprises:
a cathode panel having a display area formed on a back substrate, the display area having a number of first electrodes extending in a first direction and arranged side by side in a second direction crossing the first direction, an insulating film formed to cover the first electrodes, a number of second electrodes extending in the second direction and arranged side by side in the first direction on the insulating film, and a number of pixels arranged at intersections of the first electrodes and the second electrodes, each of the pixels having an electron source;
an anode panel having formed on a front substrate a plurality of colors of phosphor layers excited to illuminate by electrons from the electron sources in the display area on the cathode panel, and third electrodes; and
a seal frame having a seal member interposed between the cathode panel and the anode panel along their circumferential portion to hermetically join the two panels,
wherein the seal frame has integrally formed recesses, concave in cross section, in its bonding surfaces in contact with the cathode panel and the anode panel, and
wherein after the seal member is applied to the recesses, the seal frame is interposed between the cathode panel and the anode panel so as to hermetically join the two panels through the seal member.

9. A method of manufacturing an image display apparatus according to claim 8, wherein the seal frame is formed of a glass material containing silicon oxide as a main component and 1-20% by weight of at least one kind of rare earth oxide chosen from La, Sc, Y, Ce, Pr, Nd, Pm, Sm, Eu, Gd, Tb, Dy, Ho, Er, Tm, Yb and Lu.

10. A method of manufacturing an image display apparatus according to claim 8, wherein the seal frame has curved portions at its four corners, the curved portions having a radius of curvature set at 0.1 mm or less.

11. A method of manufacturing an image display apparatus according to claim 8, wherein the seal frame comprises a plurality of seal frame rods and the seal frame rods are hermetically joined with each other through a joint member.

12. A method of manufacturing an image display apparatus according to claim 8, wherein the seal member has as a main component frit glass selected from a group of Pb-based frit glass and V-based frit glass.

13. A method of manufacturing an image display apparatus according to claim 8, wherein the joint member has as a main component frit glass selected from a group of Pb-based frit glass and V-based frit glass.

14. A method of manufacturing an image display apparatus according to claim 12, wherein the joint member has a higher softening temperature than that of the seal member.
